(19) United States
(12) Patent Application Publication
(10) Pub. No.: US 2015/0068279 A1
(43) Pub. Date: Mar. 12, 2015

(54) ELECTRO-ENHANCED SOLID-PHASE MICROEXTRACTION METHOD

(71) Applicants: KING ABDULAZIZ CITY FOR SCIENCE AND TECHNOLOGY, Riyadh (SA); KING FAHD UNIVERSITY OF PETROLEUM AND MINERALS, Dhahran (SA)

(72) Inventors: CHANBASHA BASHEER, KARIMANGALAM (IN); MOUSA YASER MOUSA AMAYREH, DHAHRAN (SA)

(73) Assignees: KING ABDULAZIZ CITY FOR SCIENCE AND TECHNOLOGY, Riyadh (SA); KING FAHD UNIVERSITY OF PETROLEUM AND MINERALS, Dhahran (SA)

(21) Appl. No.: 14/024,472

(22) Filed: Sep. 11, 2013

(51) Int. Cl. G01N 30/72; H01J 49/00

(52) U.S. Cl. CPC G01N 30/72; H01J 49/0031; G01N 2030/009
USPC 73/23.37; 250/282

(57) ABSTRACT

The electro-enhanced solid-phase microextraction (EE-SPME) method involves extraction that is performed with an SPME fiber, preferably made of polydimethylsiloxane (PDMS), in the presence of an applied electric potential for a predetermined period of time. Polar analytes are extracted onto the fiber, which is the stationary phase. The solid-phase microextraction fiber is then inserted into an injection port of a gas chromatograph coupled with a mass spectrometer. The polar analytes are desorbed in the injection port, and are analyzed by GC-MS to detect and quantify the individual components. The method is particularly useful for the detection of trace amounts of plasticizers, such as phthalate esters and bisphenol A, that are known to disrupt the endocrine system of humans and animals above known levels

### BACKGROUND OF THE INVENTION

1. Field of the Invention

The present invention relates to separation techniques, and particularly to an electro-enhanced solid-phase microextraction method that is particularly useful for the detection of endocrine disruptor chemicals (EDCs) in liquid samples, such as seawater and human blood.

2. Description of the Related Art

Solid-phase microextraction (SPME) is a sample preparation technique used both in the laboratory and on-site. Developed in the early 1990s, it is a relatively simple and inexpensive technique in which solvents are not used. SPME involves the use of a fiber coated with an extracting phase, which can be either a liquid (polymer) or a solid (sorbent), which extracts different types of analytes (including both volatile and non-volatile) from different kinds of media, which may be in liquid or gas phase. The quantity of analyte extracted by the fiber is proportional to its concentration in the sample, as long as equilibrium is reached or, in the case of short time pre-equilibrium, with the help of convection or agitation. SPME extracts the analyte from the solvent onto the solid phase and concentrates the analyte so that trace amounts of the analyte may be analyzed and identified. After extraction, the analyte is desorbed from the solid phase and is typically subjected to instrumental analysis (HPLC, GC-MS, etc.) to identify and quantify the analytes of interest. For example, the SPME fiber may be transferred to the injection port of a separating instrument, such as a gas chromatograph, where desorption of the analyte takes place and analysis is carried out.

The main benefit of SPME is that the extraction is relatively fast, simple, and can typically be performed without solvents. Additionally, detection limits can reach parts per trillion (ppt) levels for certain compounds. The addition of electrical potential to the process is generally referred to as electro-enhanced solid-phase microextraction (EE-SPME).

In EE-SPME, faster transport of charged analyte from the sample toward the surface of the fiber via electrophoresis is observed, which increases the enrichment of analytes on the SPME fiber. It would obviously be desirable to be able to use a commercial SPME fiber, without any modification, for the extraction of polar analytes using electrical potential.

Phthalate esters (PAEs) are used as plasticizers in the manufacturing of plastics, polyvinyl chloride and polyethylene materials, for example, to improve their flexibility and transparency. These plasticizers easily leach under harsh environmental conditions. Bisphenol A (BPA) is a chemical produced in large quantities, primarily used as a flame retardant and stabilizer in the production of polyvinyl chloride, polycarbonate plastics, rubber, and epoxy resins.

PAEs and BPA are classified as endocrine disruptor chemicals (EDC), which are capable of causing abnormalities in invertebrates, fish, avian, reptilian, and mammalian species. Further, the carcinogenic toxicity of EDCs are well documented, even at very low concentrations, and their mode of action mimics estrogenic activity and may affect the health and reproduction systems of both humans and wildlife.

It is obviously of great importance to test for the presence of EDCs, both in the environment and within samples taken from patients, such as blood samples. In this regard, a variety of different pre-concentration techniques have been developed to extract EDCs from aqueous samples, including liquid-liquid extraction (LLE) and solid-phase extraction (SPE). However, LLE and SPE require relatively large volumes of organic solvents and multi-step extractions. Thus, these techniques are not suitable for trace level determination of EDCs in water and food samples. Liquid phase microextraction (LPME) and dispersive liquid-liquid microextraction (DLLME) have also been tested for extraction of PAEs from aqueous samples. However, the selection of suitable solvents for the extraction of polar analytes, such as PAEs and BPA, is a challenging task in LPME and DLLME.

Thus, an electro-enhanced solid-phase micro extraction method solving the aforementioned problems are desired.

### SUMMARY OF THE INVENTION

The electro-enhanced solid-phase microextraction (EE-SPME) method is used to detect endocrine disruptor chemicals (EDCs), such as diethyl phthalate (DEP), di-n-butyl phthalate (DBP), bisphenol A (BPA) and butylbenzyl phthalate (BBP) in liquid samples, such as seawater and human blood samples. The EE-SPME method involves extraction that is performed with an SPME fiber, preferably made of polydimethylsiloxane (PDMS), over an extraction time of about 20 minutes and with an applied electrical potential of about 32 V. Additionally, 5% (w/v) NaCl may be added to each liquid sample in order to increase the ionic strength and decrease the analyte solubility in the aqueous solution.

The electro-enhanced solid-phase microextraction is performed on the liquid sample to extract the endocrine disruptor chemicals therefrom onto a solid-phase microextraction fiber. The solid-phase microextraction fiber is then inserted into an injection port of a gas chromatograph coupled with a mass spectrometer. The endocrine disruptor chemicals are desorbed from the solid-phase microextraction fiber within the injection port. Gas chromatography and mass spectrometry are then performed on the endocrine disruptor chemicals to determine presence and concentrations thereof.

These and other features of the present invention will become readily apparent upon further review of the following specification and drawings.

### BRIEF DESCRIPTION OF THE DRAWINGS

FIG. 1 illustrates an electro-enhanced solid-phase microextraction (EE-SPME) apparatus for implementing the electro-enhanced solid-phase microextraction method according to the present invention.

FIG. 2 is a graph showing enrichment factors of diethyl phthalate (DEP), di-n-butyl phthalate (DBP), bisphenol A (BPA) and butylbenzyl phthalate (BBP) over a varying extraction time to find an optimal extraction time for a conventional solid-phase microextraction method.

FIG. 3 is a graph showing enrichment factors of diethyl phthalate (DEP), di-n-butyl phthalate (DBP), bisphenol A (BPA) and butylbenzyl phthalate (BBP) over a 20-minute extraction time with varying applied electrical potential in the electro-enhanced solid-phase microextraction method according to the present invention.

FIG. 4 is a graph showing enrichment factors of diethyl phthalate (DEP), di-n-butyl phthalate (DBP), bisphenol A (BPA) and butylbenzyl phthalate (BBP) over a 20-minute extraction time with an applied electrical potential of 32 V in aqueous samples having varying salt (NaCl) concentrations using the electro-enhanced solid-phase microextraction method according to the present invention.

FIG. 5 is a graph showing enrichment factors of diethyl phthalate (DEP), di-n-butyl phthalate (DBP), bisphenol A (BPA) and butylbenzyl phthalate (BBP) over a varying extraction time with an applied electrical potential of 32 V in aqueous samples having salt concentrations of 5% NaCl using the electro-enhanced solid-phase microextraction method according to the present invention.

FIG. 6 is a total gas chromatography-mass spectrometry (GC-MS) ion chromatogram comparing endocrine disruptor chemicals (EDCs) extracted using the electro-enhanced solid-phase microextraction method in seawater samples spiked with DEP, DBP, BPA and BBP analytes at concentrations of 50 μg/L.

FIG. 7 is a total gas chromatography-mass spectrometry (GC-MS) ion chromatogram comparing endocrine disruptor chemicals (EDCs) extracted using the electro-enhanced solid-phase microextraction method in human blood samples spiked with DEP, DBP, BPA and BBP analytes at concentrations of 30 μg/L.

Similar reference characters denote corresponding features consistently throughout the attached drawings.

### DETAILED DESCRIPTION OF THE PREFERRED EMBODIMENTS

The electro-enhanced solid-phase microextraction (EE-SPME) method involves extraction that is performed with an SPME fiber, preferably made of polydimethylsiloxane (PDMS), in the presence of an applied electric potential for a predetermined period of time. Polar analytes are extracted onto the fiber, which is the stationary phase. The solid-phase microextraction fiber is then inserted into an injection port of a gas chromatograph coupled with a mass spectrometer. The polar analytes are desorbed in the injection port, and are analyzed by GC-MS to detect and quantify the individual components. The method is particularly useful for the detection of trace amounts of plasticizers, such as phthalate esters and bisphenol A, that are known to disrupt the endocrine system of humans and animals above known levels.

For purposes of laboratory testing, stored blood samples were collected from a blood bank of a local hospital in Al-Khobar, Saudi Arabia. Seawater samples were collected from the coastal area of Al-Khobar in pre-cleaned glass bottles. The blood samples were treated with an anticoagulant and stored at a temperature of 4° C. Samples for analysis were directly extracted using the present electro-enhanced solid-phase microextraction (EE-SPME) method without any further pre-treatment.

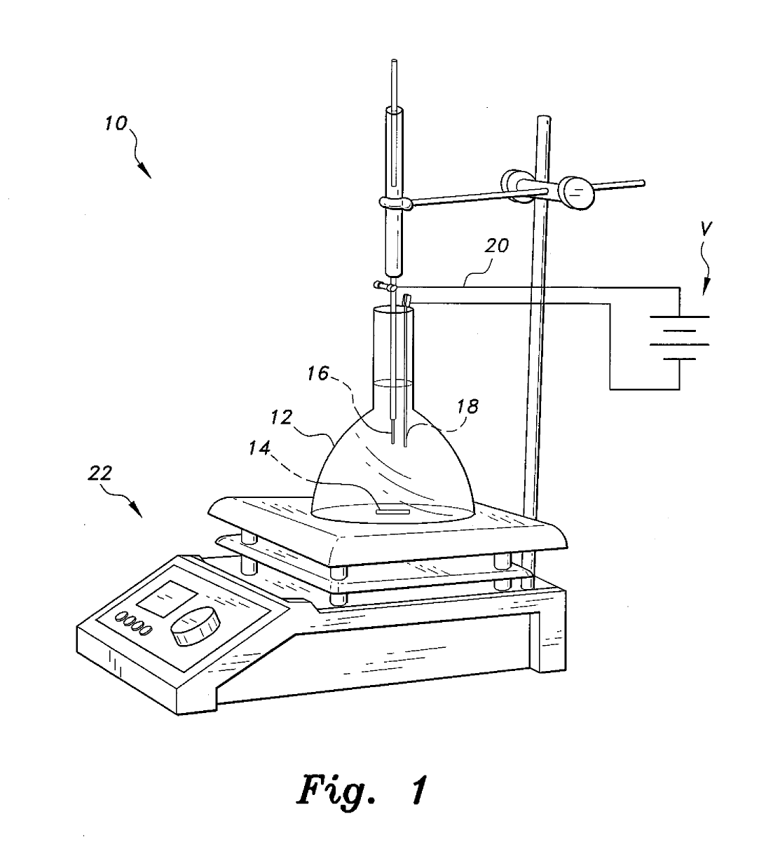

As shown in FIG. 1, using the EE-SPME apparatus 10, a 10 mL sample solution spiked with endocrine disruptor chemicals (EDCs) was placed in a volumetric flask 12 with a magnetic stir bar 14. An SPME fiber 16 and an inert metallic wire 18 that was used as an electrode were inserted in the sample solution. In the experiments, the SPME fiber was a 30 pm diameter polydimethylsiloxane (PDMS) fiber. Both the metallic wire 18 and the SPME fiber 16 were connected via cable wires 20 to a DC power supply V. A positive potential (+32 V) was applied to the SPME fiber 16 and a negative potential (−32 V) was applied to the inert metallic wire 18. The SPME fiber 16 was immersed in the sample solution within flask 12, as shown. Then, the sample was agitated at 800 RPM using a magnetic stirrer 22 for a period of 20 minutes. After the extraction, the fiber 16 was desorbed in a gas chromatograph-mass spectrometer (GC-MS) injection port for three minutes at a temperature of 290° C.

Analyses were carried out using a gas chromatograph coupled with a mass spectrometer. An HP-1 methyl siloxan column (30 m×320 μm×1 μm thickness) was used. High purity helium (>99.999%) was used as a carrier gas, and the samples were analyzed in a constant flow at 1.2 mL/min. The oven temperature program used for the analyses was as follows. The initial temperature was 55° C., held for 15 minutes, which was then increased to 250° C. at a rate of 6° C./minute, held for two minutes. Samples were analyzed in splitless mode. For qualitative determinations, the mass spectrometer was operated in full-scan mode from m/z 50 to 550. For quantitative determinations, the mass spectrometer was operated in selected ion monitoring (SIM) mode.

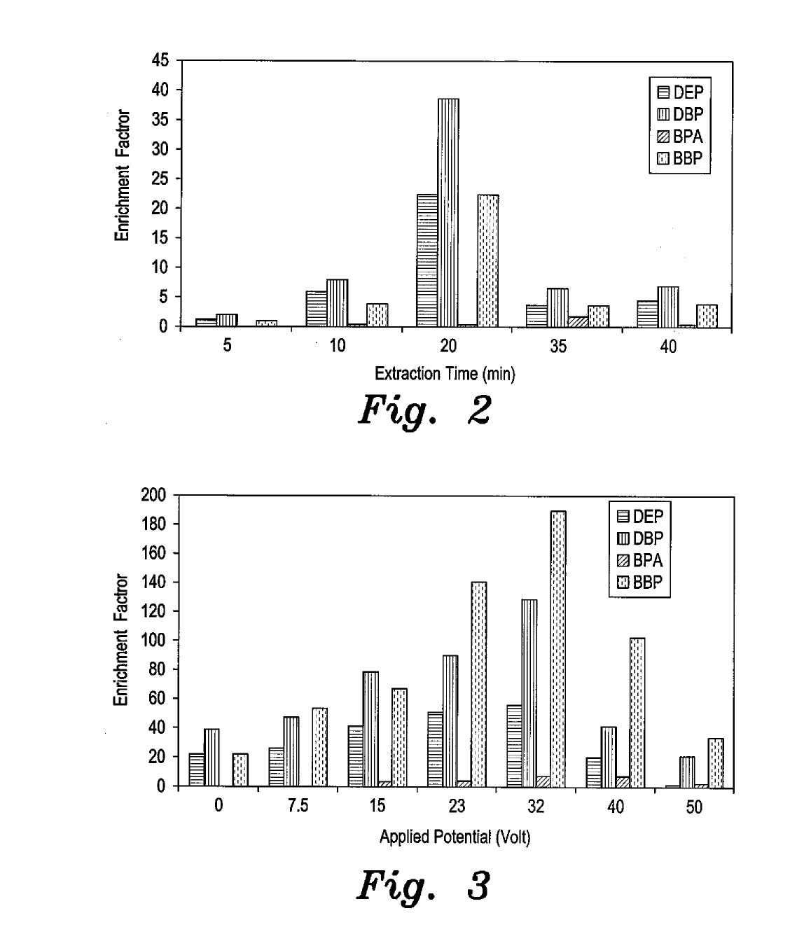

The optimum absorption time can be obtained when there are no additional increases in peak areas with further time of extraction. The influence of extraction time on the SPME enrichment factor was studied with the time varying between 5 and 40 minutes at room temperature, and with the samples being stirred at 800 RPM. FIG. 2 shows the enrichment of PAEs and BPA using direct immersion solid-phase microextraction (DI-SPME), which occurs without the addition of an electrical potential. The enrichment factor for the PAEs and BPA slowly increased as the extraction time varied from 5 to 20 minutes and then reached equilibrium at about 20 minutes. Based on the results, 20 minutes was selected for further studies regarding applied electrical potential and salt addition. FIG. 2 compares the extraction times of four different analytes, namely, diethyl phthalate (DEP), di-n-butyl phthalate (DBP), bisphenol A (BPA) and butylbenzyl phthalate (BBP).

The effect of applied potential on the present EE-SPME method was studied by plotting the analyte enrichment factor as a function of applied potential, as shown in FIG. 3. Potential was varied between 7.5 V and 50 V in the SPME method, using an extraction time of 20 minutes. The results of FIG. 3 show that the enrichment factor for the PAEs and BPA increased as the potential varied between 7.5 V and 32 V, and then decreased. The application of positive potentials made the fiber coating positively charged, thus enhancing the extraction of deprotonated ions of the target compound via electrophoresis and complementary charge interaction. At higher potentials (greater than 32 V), bubble formation on the SPME fiber reduced the active surface area of the polymer coating. Thus, an optimum applied potential of 32 V was selected for further analysis. FIG. 3 shows results for the same four analytes used in the results of FIG. 2.

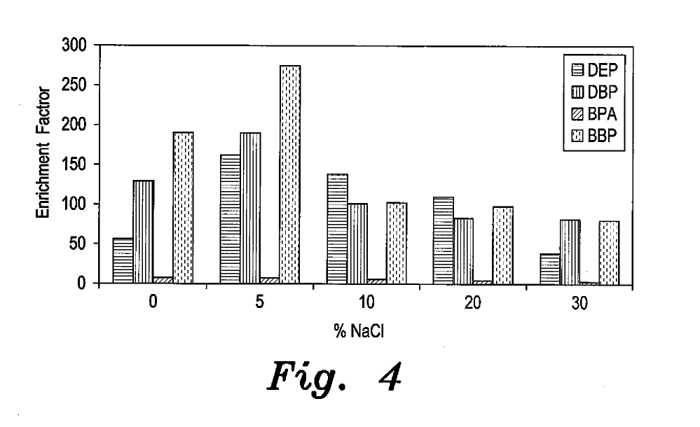

FIG. 4 shows the effect of salt (NaCl) addition on enrichment factor for the same four analytes studied in FIGS. 2 and 3. It is common to add NaCl to increase the ionic strength and decrease the analyte solubility in aqueous solutions. The effect of NaCl on the extraction was evaluated between 0% and 30% (w/v). An extraction time of 20 minutes was used, with an applied potential of 32 V. The results of FIG. 4 show the enrichment factors were highest at 5% NaCl for all analytes. Increases in the overall ionic strength at concentrations greater than 5% NaCl showed decreases in the enrichment factors. This may be due to a decrease in the diffusion coefficient of each analyte by increasing the viscosity of the aqueous sample.

Based on these results, 5% NaCl was added to the aqueous samples for subsequent experiments.

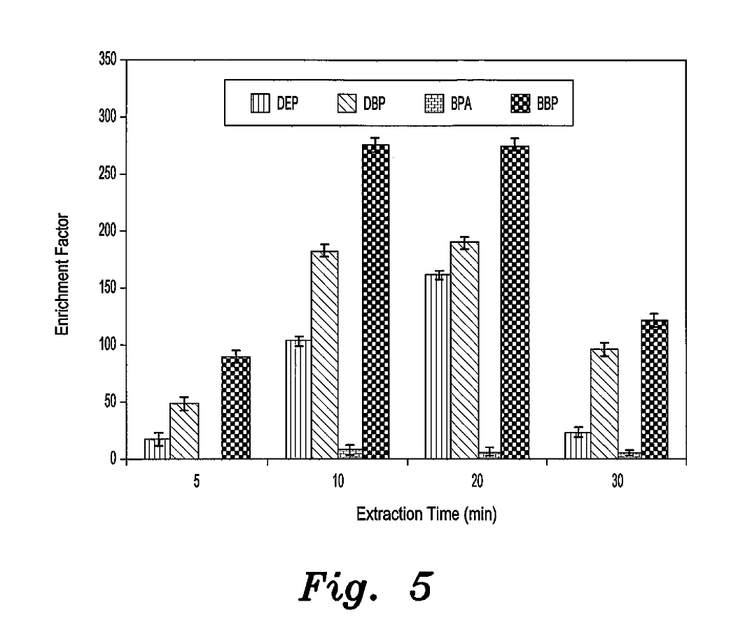

FIG. 5 shows the extraction performance of electro-enhanced SPME at different extraction times. The EE-SPME method provides higher enrichment factors for all analytes when compared to conventional SPME (as shown in FIG. 2). From these results, the lower enrichment factor at 30 minutes is most likely due to bubbles observed on the fiber at longer extraction times, which inhibits and reduces the target analytes' absorption.

In order to evaluate the present EE-SPME method, the linear range, repeatability and limits of detection (LODs) were investigated under the above optimized conditions (extraction time of 20 minutes, salt concentration of 5% NaCl, with an applied potential of 32 V). The results are summarized in Table 1 below.

TABLE 1
Features of EE-SPME method

| | Linearity | | | RSDs | LODs |
|---|---|---|---|---|---|
| Compound | range (μg/L) | R² | Equation | (n = 9)^{a} | (S/N = 3) |
| DEP | 1.0-100 | 0.991 | y = 3 × 10⁻⁵x + 2.4087 | 4.5 | 0.15 |
| DBP | 1.0-100 | 0.996 | y = 1 × 10⁻⁵x − 1.7262 | 1.0 | 0.004 |
| BBP | 1.0-100 | 0.980 | y = 2 × 10⁻⁵x + 1.9972 | 3.3 | 0.1 |
| BPA | 2.0-100 | 0.963 | y = 1.6 × 10⁻⁵x −23.6 | 5.0 | 0.096 |

^{a}Under repeatability condition, coefficient of determination (R²), linear equations, Relative standard deviations (% RSDs), limits of detections (LODs) for PAEs and BPA by EE-SPME/GC-MS

Very good linearity was observed over the concentration range of 1 to 100 μg/L for PAEs and BPA, with a favorable coefficient of determination (R²) ranging between 0.963 and 0.996. The enrichment factor for the BBP analyte was highest, with an average value of about 274. The repeatability study was carried out by extracting spiked water samples at differing concentration levels of 1, 5, 10, 20, 40, 60, and 100 μg/L, and the percentage relative standard deviations (% RSDs) were between 1.0 and 5.0% (n=9). The LODs, based on a signal-to-noise ratio (SN) of 3, ranged from 0.004 to 0.15 μg/L. Performance of the present EE-SPME method was compared with those of other conventional methods and the results are shown below in Tables 2A and 2B. These methods include solid-phase microextraction with liquid chromatography with diode array detection (SPME/HPLC-DAD) and solid-phase microextraction (without electro-enhancement) with gas chromatography and mass spectrometry (SPME/GC-MS), compared against the present method using electro-enhanced solid-phase microextraction with gas chromatography and mass spectrometry (EE-SPME/GC-MS), and for varying types of SPME fiber, including polydimethylsiloxane (PDMS), polydimethylsiloxane/divinylbenzene (PDMS/DVB) and polyacrylate (PA). With regard to detection of PAEs, the results shown below in Tables 2A and 2B clearly indicate that the EE-SPME performance is superior to that of conventional SPME. A comparable result was obtained for BPA. The EE-SPME/GC-MS method provides a high enrichment factor, along with the process being relatively fast and easy to implement.

TABLE 2A
Comparison of EE-SPME/GC-MS with Conventional Methods
for Determination of PAEs

| | | | Extraction | L.R | LODs | % |
|---|---|---|---|---|---|---|
| Method | Fiber | Sample | time (min) | μg/L | μg/L | RSD |
| SPME/ | PDMS | Water | 20 | — | 1.0-2.5 | 5.0-20 |
| HPLC- | | | | | | |
| DAD^{a} | | | | | | |
| SPME/GC- | PA | Water | 90 | 0.02-10 | 0.02-0.17 | 4.2-5.9 |
| MS | | | | | | |
| EE-SPME/ | PDMS | Water | 20 | 1-100 | 0.004-0.15 | 1.0-4.5 |
| GC-MS | | | | | | |

L.R: Linearity Range.
LOD: Limits of Detection.
% RSD: Relative standard deviation.
^{(a)}Solid phase extraction coupling with GCMS.

TABLE 2B
Comparison of EE-SPME/GC-MS with Conventional Methods
for Determination of BPA

| | | | Extraction | L.R | LODs | % |
|---|---|---|---|---|---|---|
| Method | Fiber | Sample | time (min) | μg/L | μg/L | RSD |
| SPME/ | PDMS | Milk | 30 | 1-10 | 0.01-0.1 | 4.1-5.8 |
| GC-MS | | | | | | |
| SPME/ | PDMS/ | Water | 60 | 0.03-195 | 0.04-1.0 | 6-9 |
| GC-MS | DVB | | | | | |
| EE-SPME/ | PDMS | Water | 20 | 2-100 | 0.096 | 4.2-5 |
| GC-MS | | | | | | |

L.R: Linearity Range.
LOD: Limits of Detection.
% RSD: Relative standard deviation.
^{(a)}Solid phase extraction coupling with GCMS.

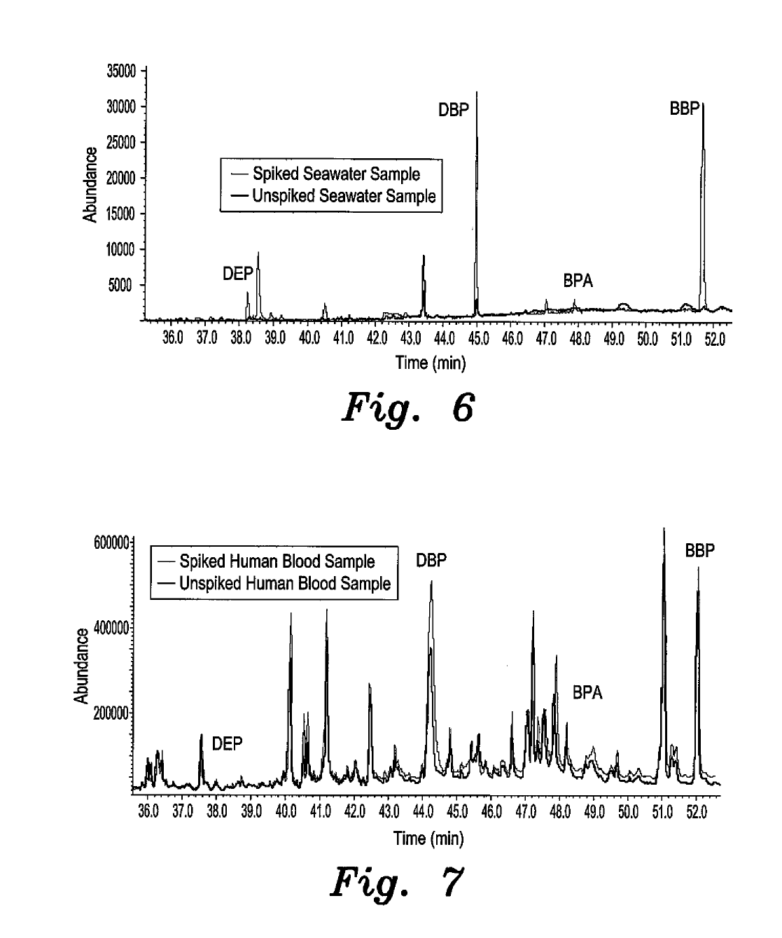

In order to demonstrate the feasibility of the EE-SPME/GC-MS method, the optimized conditions were applied to human blood samples (stored in transfusion bags in a local hospital blood bank) and seawater. Ten milliliters of each were used for the EE-SPME extraction. PAEs were detected in all samples, with the highest concentration of 54.5 μg/L of DEP being detected in blood samples, whereas 36.5 μg/L of BBP was detected in seawater samples. BPA was not detected in either of the samples. In order to assess the matrix effect of the EE-SPME method, real samples were spiked with 20 μg/L of target analytes and the extraction recoveries were calculated. Recoveries for PAEs in the seawater and blood samples ranged between 89.6% and 95%, while for BPA the range was between 73.9% and 87.1%. FIGS. 5 and 6 shows the GC-MS total ion chromatograms of spiked and unspiked seawater and blood samples, respectively. In both FIGS. 5 and 6, the respective seawater and blood samples were spiked with DEP, DBP, BPA and BBP analytes. In FIG. 6, the seawater was spiked with the analytes at concentrations of 50 μg/L. In FIG. 7, the blood samples were spiked with the analytes at concentrations of 30 μg/L.

It is to be understood that the present invention is not limited to the embodiments described above, but encompasses any and all embodiments within the scope of the following claims.

We claim:

1. An electro-enhanced solid-phase microextraction method of detecting polar compounds, comprising the steps of:
inserting a solid-phase microextraction fiber and an electrode into a liquid sample containing polar compounds without preconditioning of the fiber and the electrode;
applying a DC voltage potential between the fiber and the electrode in order to extract the polar compounds onto the fiber;
inserting the solid-phase microextraction fiber into an injection port of a gas chromatograph coupled with a mass spectrometer;
desorbing the polar compounds from the solid-phase microextraction fiber within the injection port; and
analyzing the polar compounds by gas chromatography and mass spectrometry to detect and quantify the polar compounds.

2. The electro-enhanced solid-phase microextraction method as recited in claim 1, wherein the polar compounds comprise endocrine disruptors selected from the group consisting of phthalate esters and bisphenol A.

3. The electro-enhanced solid-phase microextraction method as recited in claim 1, wherein the step of applying a DC voltage is performed over an extraction period of 20 minutes.

4. The electro-enhanced solid-phase microextraction method as recited in claim 1, further comprising the step of adding 5% (w/v) NaCl to the liquid sample.

5. The electro-enhanced solid-phase microextraction method as recited in claim 1, further comprising the step of agitating of the liquid sample during the step of applying the DC voltage potential.

6. The electro-enhanced solid-phase microextraction method as recited in claim 1, wherein the solid-phase microextraction fiber comprises a polydimethylsiloxane solid-phase microextraction fiber.

7. The electro-enhanced solid-phase microextraction method as recited in claim 1, wherein the step of desorbing the polar compounds is performed over a time period of about three minutes at a temperature of about 290° C.

8. The electro-enhanced solid-phase microextraction method as recited in claim 1, wherein the liquid comprises seawater.

9. The electro-enhanced solid-phase microextraction method as recited in claim 1, wherein the liquid sample comprises human blood.
